(19) United States
(12) Patent Application Publication
(10) Pub. No.: US 2006/0206744 A1
(43) Pub. Date: Sep. 14, 2006

(54) Low-power high-throughput streaming computations

(75) Inventors: Srihari Cadambi, Cherry Hill, NJ (US); Pranav N. Ashar, Belle Meade, NJ (US)

Correspondence Address: NEC LABORATORIES AMERICA, INC., 4 INDEPENDENCE WAY, PRINCETON, NJ, 08540, US

(73) Assignee: NEC Laboratories America, Inc., Princeton, NJ (US)

(21) Appl. No.: 11/075,277

(22) Filed: Mar. 8, 2005

(51) Int. Cl. G06F 1/30

(52) U.S. Cl. 713/600; 345/506; 713/324

(57) ABSTRACT

A method for optimizing voltage and frequency for pipelined architectures that offers better power efficiency. The invention provides methods for low-power high-throughput hardware implementations to stream computations by partitioning a computation into temporally distinct stages, assigning a clock frequency to each stage such that an overall computational throughput is met and assigning to each stage a supply voltage according to its respective clock frequency and circuit parameters.

### BACKGROUND

The invention relates generally to the field of pipelined hardware architecture. More specifically, embodiments of the invention relate to systems and methods for implementing power efficient hardware solutions for streaming computations.

Low power consumption and high performance are important requirements for any signal processing hardware design. Mobile multimedia systems are becoming popular consumer items, but limited battery life continues to be a problem. Energy efficiency must be balanced against the fact that users demand a high quality of service. With the ever increasing number of battery-operated devices, the need for minimizing power consumption without compromising performance is essential.

The practice of using data pipelines for streaming computations leads to high performance. Pipelining breaks up a complex operation performed on a stream of data into smaller sequential stages or subprocesses where the output of one subprocess feeds into the next. When implemented properly, multiple operations can be performed concurrently even if one step normally would depend on the result of the preceding step before it can start. Pipelining improves performance by reducing the idle time or latency of each piece of hardware. Conversely, the pipelined stages must be designed to make the pipeline balanced, so that the different stages take approximately the same time to complete. With each clock cycle, new data is input to one end of the pipeline and a completed result will be output from the other end.

Pipelining enables the realization of high-speed, high-efficiency complementary metal oxide semiconductor (CMOS) data paths by allowing for the reduction of supply voltages to the lowest possible levels while still satisfying throughput constraints. In deep pipelines, however, registers and corresponding clock trees are responsible for an increasingly large fraction of total dissipation, no matter how efficiently they may have been implemented.

One application that naturally lends itself to pipelining is video processing, a key component of streaming multimedia communications and an integral part of next-generation portable devices. Currently, there are several video standards established for different purposes such as MPEG, JPEG 2000 and others, and their implementations for mobile systems-on-a-chip (SoCs) provide substantial computing capabilities at low energy consumption levels. The requirements of these standards incorporate demanding computations that include the discrete cosine transform (DCT) and inverse discrete cosine transform (IDCT), the discrete wavelet transform (DWT) and inverse discrete wavelet transform (IDWT), motion estimation, motion compensation, variable-length coding/decoding, quantization and inverse quantization. JPEG 2000 is a recently developed standard for digital image processing and individually compresses each frame in a moving picture. Implementations of JPEG 2000 may be used in applications ranging from battery-operated cameras where low-power consumption is desirable, to digital cinema which requires real-time decompression of high-resolution images.

Streaming computations are numeric operations in which data flow is unidirectional and uninterrupted from a primary input or inputs, to a primary output or outputs. During computation, however, the data flow can experience transformations where the amount of data being processed changes. Data can increase progressively as it is processed through a plurality of stages due to external inputs or internal generation due in part to signal processing techniques like the Nyquist criteria. Most current implementations are synchronous, using a global clock to pace all operations of a system or device where all components of the system operate once per clock cycle. However, using a global clock reduces efficiency.

To illustrate the association of power and frequency, the delay of a logic gate T_{d} is given by

$${T}_{d} = \frac{{C}_{L} {xV}_{dd}}{μ {C}_{ox} ( W / L ) {( {V}_{dd} - {V}_{th} )}^{2}} , \qquad ( 1 )$$

where C_{L} is the load capacitance, V_{dd} the supply voltage, Vₜₕ the device threshold voltage, W and L the width and length of the transistor channels, Cₒₓ the oxide capacitance and μ the mobility. CMOS transistors have a source-drain channel formed only when their gate voltage is larger than Vₜₕ. If the source-drain voltage V_{dd} is greater than the gate voltage, the transistor operates in a saturation mode where they exhibit switch-like properties required for logic circuit design. Keeping all device parameters and circuit topology constant, T_{d} is inversely proportional to the supply voltage V_{dd} if operation is over the threshold voltage.

The delay T_{d} approximately doubles if the voltage is halved. Conversely, if the frequency is halved, the voltage can be reduced in practice.

In addition to logic gate delay Td, the power P consumed by a CMOS device is
P=C_{L}V_{dd}²f (2)

where f is the frequency. As can be seen, power has a quadratic dependence on the supply voltage V_{dd}, and a linear relationship with the frequency f of operation. Since power consumption is proportional to clock frequency, the difference becomes more important at higher operating frequencies.

FIG. 1a shows a single computation block C transformed into two discrete computation blocks that can be evaluated in a parallel configuration (spatially parallel) as shown in FIG. 1b or in a pipelined configuration (temporally parallel) as shown in FIG. 1c. Computation block C has two inputs, Dᵢₙ₁ and Dᵢₙ₂ and a single output Dₒᵤₜ. Each data element in the data stream has a binary word length and communication can be serial (w=1) or parallel (w=2, 3, 4, . . . n, a plurality of lines corresponding to a binary word length). In order to operate, computation block C requires a supply voltage V and a clock frequency f.

When the functional requirement of computation block C is decomposed into a system of parallel computation blocks C₁ and C₂ as in FIG. 1b, each block can be clocked at half the frequency of computation block C,

$$\frac{f}{2} ,$$

while maintaining the same data throughput. Voltages V₁ and V₂ supplied to blocks C₁ and C₂ can be reduced by

$$\frac{1}{2} ( \frac{V}{2} )$$

in proportion to the frequency

$$\frac{f}{2}$$

and are equal V₁=V₂. While voltage and frequency decrease by a factor of two, the total system capacitance increases approximately by a factor of two due to the parallel implementation. Power has a cubic relationship with voltage and frequency as shown in equations (1) and (2), leading to a 4× reduction in power. In practice, the power reduction is not as great due to additional wiring capacitances and smaller voltage reductions due to threshold voltage restrictions.

When computation block C is functionally decomposed into a pipeline comprising serial computation blocks C₃ and C₄ as in FIG. 1c, additional latches are inserted at the boundary between blocks C₃ and C₄. The latches enable the components of a pipeline to operate on different portions of the same data stream. Even though the frequency is f, the critical path through the computation block C is split by the latches. In FIG. 1a, the delay through computation block C is

$$\frac{1}{f} .$$

In FIG. 1c, the delay through each computation block is

$$\frac{1}{f}$$

yielding a total delay of

$$\frac{2}{f} ,$$

and the number of circuit elements in the critical path is reduced by two. The circuit elements within blocks C₃ and C₄ can have a larger delay and supply voltage V₃ can be reduced (V₃<V). The supply voltage V₃ and frequency f can be reduced by a factor of two leading to a 4× reduction in power. However, capacitance remains unchanged since the hardware for blocks C₃ and C₄ together constitute computation block C. In practice, power reduction is not as great due to extra capacitance added by latches and smaller voltage reductions.

In terms of power consumption, the transformation of computation block C shown in FIG. 1b is better than the transformation shown in FIG. 1c. In terms of performance, the transformations shown in FIGS. 1b and 1c are approximately equal.

Most existing parallel and pipelined computations use a single global clock and voltage supply. To decrease power consumption, voltage scaling has been employed which uses software controlled voltage modulation based on run-time demands. Other current design efforts for low power operation lower voltage for portions of the circuit, i.e., voltage islands, which are removed from the critical path. A power efficient solution for stream-based pipelines having a plurality of stages but with different computational requirements in each stage has not yet been proposed.

### SUMMARY

A method for optimizing voltage and frequency for pipelined architectures that offers better power efficiency is not available. The inventors have discovered that it would be desirable to have a method of implementing pipelined architectures that result in reduced power consumption while maintaining high throughput by determining frequencies and voltages in conjunction with semiconductor parameters that are dependent upon the amount of streaming data processed in each stage of the pipeline.

One aspect of the invention provides methods for implementing a computation as a pipeline that processes streaming data. Methods according to this aspect of the invention preferably start with partitioning the computation into a plurality of temporal stages, each stage having at least one input and at least one output, wherein one of the stages is a first stage having at least one primary input and one of the stages is a last stage having at least one primary output, each stage defined by a clock frequency. Forming a pipeline by coupling at least one output from the first stage to at least one input of another one of the plurality of stages, and coupling at least one output from another one of the plurality of stages to at least one input for the last stage. Assigning a clock frequency to each one of the stages in the pipeline such that an overall throughput requirement is met and not all of the assigned stage clock frequencies are equal and assigning to each stage in the pipeline a supply voltage where not all of the assigned stage voltages are equal.

Another aspect of the method of the invention is inserting at least one storage element in at least one of the plurality of stages in the pipeline to allow for operational independence between the storage element stage and another one of the plurality of stages.

Yet another aspect of the method of the invention is an inverse discrete wavelet pipeline implementation having at least one reconstruction channel having a low input, a high input and an output, a row processing stage having a row reconstruction channel; the row reconstruction channel output coupled to a row stage storage element first input, the row storage element having a corresponding first output, and the row storage element having a second input and a corresponding second output, a third input and a corresponding third output, and a fourth input and a corresponding fourth output.

Other objects and advantages of the systems and methods will become apparent to those skilled in the art after reading the detailed description of the preferred embodiments.

### BRIEF DESCRIPTION OF THE DRAWINGS

FIG. 1a is a diagram of an exemplary single computation block.

FIG. 1b is a diagram of an exemplary parallel computation.

FIG. 1c is a diagram of an exemplary pipeline computation.

FIGS. 2a and 2b is a diagram of an exemplary method of the invention.

FIG. 3 is a diagram of an exemplary pipeline in accordance with the invention.

FIG. 4 is a diagram of an exemplary pipeline including a storage element in accordance with the invention.

FIG. 5 is a diagram of an exemplary forward DWT.

FIG. 6 is a diagram of an exemplary transverse digital filter.

FIG. 7a is a diagram of an exemplary N row by M column array.

FIG. 7b is a diagram of an exemplary row decomposition of the array of FIG. 7a.

FIG. 7c is a diagram of an exemplary one level decomposition of the array of FIG. 7a.

FIG. 7d is a diagram of an exemplary two level decomposition of the array of FIG. 7a.

FIG. 7e is a diagram of an exemplary three level decomposition of the array of FIG. 7a.

FIG. 7f is a diagram of an exemplary four level decomposition of the array of FIG. 7a.

FIG. 8 is a data flow of an exemplary two level DWT.

FIG. 9 is a diagram of an exemplary IDWT.

FIG. 10a is a schematic of an exemplary IDWT column stage in accordance with the invention.

FIG. 10b is a schematic of an exemplary IDWT row stage in accordance with the invention.

FIGS. 11a-11e is an exemplary data flow of a five level, IDWT using the stages of FIGS. 10a and 10b.

### DETAILED DESCRIPTION OF THE PREFERRED EMBODIMENTS

Embodiments of the invention will be described with reference to the accompanying drawing figures wherein like numbers represent like elements throughout. Before embodiments of the invention are explained in detail, it is to be understood that the invention is not limited in its application to the details of the examples set forth in the following description or illustrated in the figures. The invention is capable of other embodiments and of being practiced or carried out in a variety of applications and in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. The terms “mounted,” “connected,” and “coupled” are used broadly and encompass both direct and indirect mounting, connecting, and coupling. Further, “connected” and “coupled” are not restricted to physical or mechanical connections or couplings.

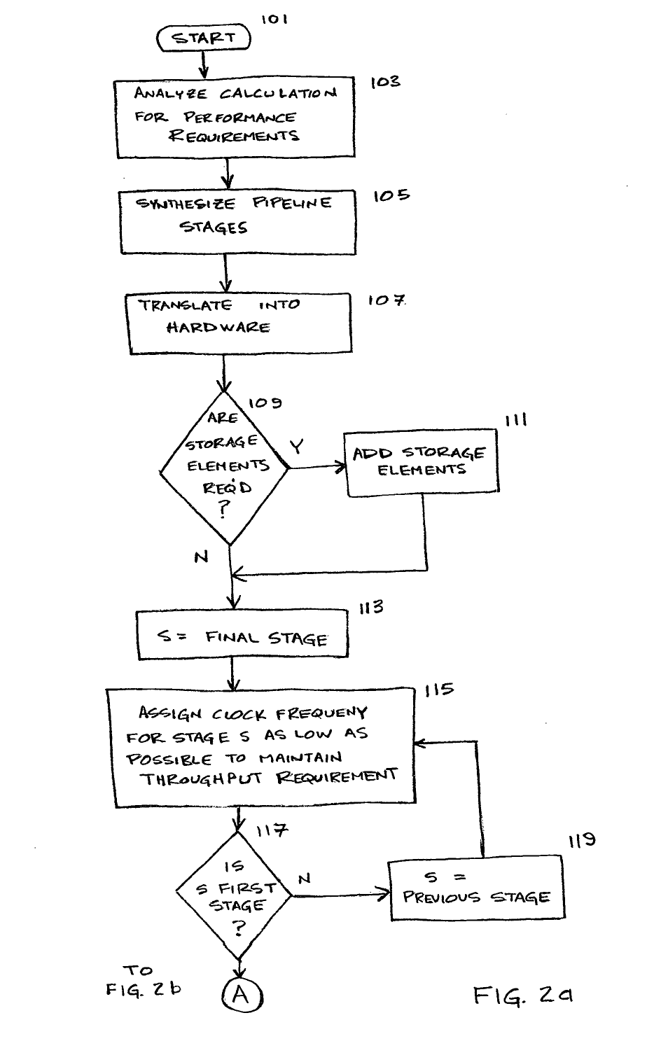

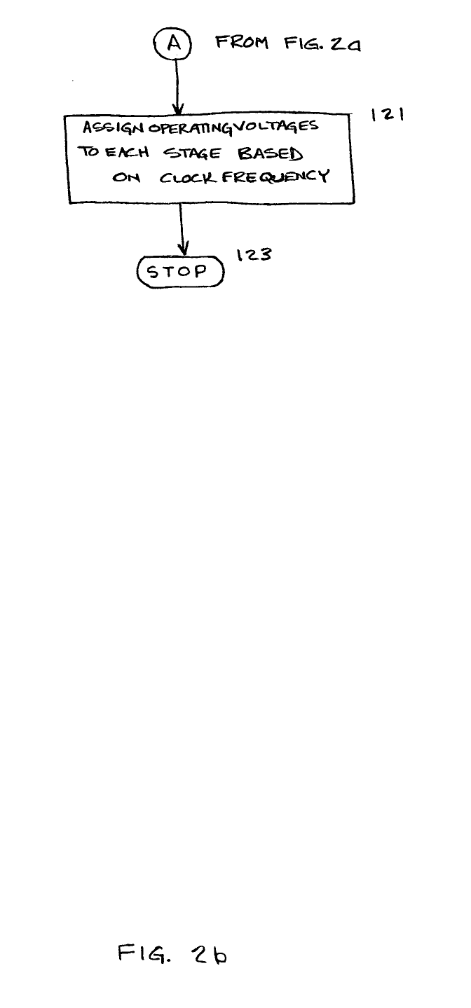

Shown in FIGS. 2a and 2b is the method of the invention. The method begins (step 101) with the examination of the computation for pipelining to determine performance requirements such as overall throughput required, number of bits for each data element in the data stream, number of discrete operations, inputs and outputs, and the like (step 103). The computation is partitioned temporally into a plurality of distinct pipeline stages (step 105) defined by a clock frequency.

A typical high-level synthesis algorithm comprises a number of steps. The operations within a computation are decomposed into a standard set of operations supported by the pipeline stages. For example, multiplications are broken up into addition and shift operations. Then, an interconnected network of standard operations is formed and allocated to available stages in the pipeline. One algorithm for performing this task is list scheduling, where the given network is topologically sorted and each operation is assigned to a component in the pipeline stage capable of executing it. An operation is assigned only after its predecessors in the network have been assigned. Based on granularity, different operations in the network may be allocated to the same pipeline stage or different stages. Operations in different pipeline stages are temporally divided from each other by latches between stages. Several practical heuristics exist to synthesize a pipeline with minimal stages, minimal latency, etc. A more detailed discussion of the synthesis step is beyond the scope of this disclosure. After synthesis, the operation(s) performed within each stage is translated into a hardware equivalent (step 107).

Depending upon the performance/computation requirements (step 103) and synthesis (step 105), a storage element with write and read functionality may be inserted within a pipeline stage (steps 109, 111) if required. Storage elements are used to maintain continuous data flow and may or may not be required.

Once the hardware is synthesized and storage element allocation is complete, clock frequencies are assigned to each pipeline stage, starting with the final stage (step 113). The frequency of the final stage is determined to be as low as possible while maintaining the design throughput requirement. The clock frequency for each preceding stage is determined, set as low as possible while maintaining the design throughput (steps 115, 117, 119) until the clock frequencies for all stages in the pipeline are set to their lowest possible values.

After all stage clock frequencies have been assigned, the operating voltage for each pipeline stage is determined according to the respective clock frequencies (steps 121, 123). As discussed above, supply voltage V_{dd} and time delay T_{d} are inversely proportional, which makes voltage V_{dd} and frequency f directly proportional. If the clock frequency for a preceding stage is halved, its supply voltage can likewise be halved so long as the stage supply voltage V_{dd} is higher than the hardware threshold voltage Vₜₕ as previously discussed.

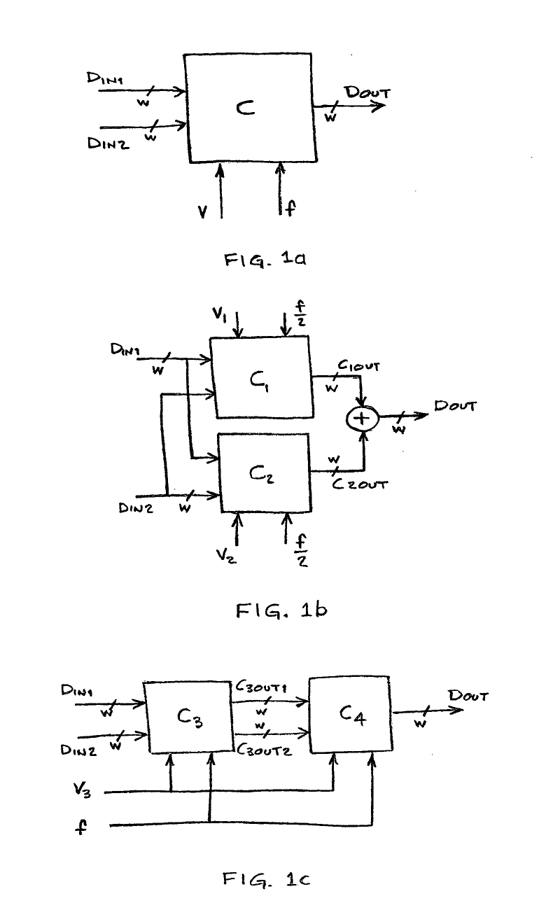

FIG. 3 shows an exemplary pipeline resulting from the method of the invention. For an overall process or computation block C, such as that shown in FIG. 1a, block C is partitioned into a plurality of stages. For this example, bock C is partitioned into two stages, C₅ and C₆. Based upon the data processing functions performed within stage C₅, the clock frequency f₅ supplied to stage C₅ is twice the frequency of f₆(f₅=2f₆) and a switching element sw is required at the input of stage C₅ to ensure both inputs, Dᵢₙ₁ and Dᵢₙ₂, are provided to stage C₅ at the predetermined frequency f₅. Switching element sw time-multiplexes the two inputs Dᵢₙ₁, and Dᵢₙ₂ into a single input at twice the frequency. The voltage V₆ supplied to stage C₆ is set as low as possible, corresponding to the clock frequency f₆ requirements of stage C₆, but greater than the hardware threshold voltage Vₜₕ of stage C₆. The voltage V₅ supplied to stage C₅ is then set as low as possible, corresponding to the clock f₅ requirements of stage C₅, but greater than the hardware threshold voltage Vₜₕ of stage C₅.

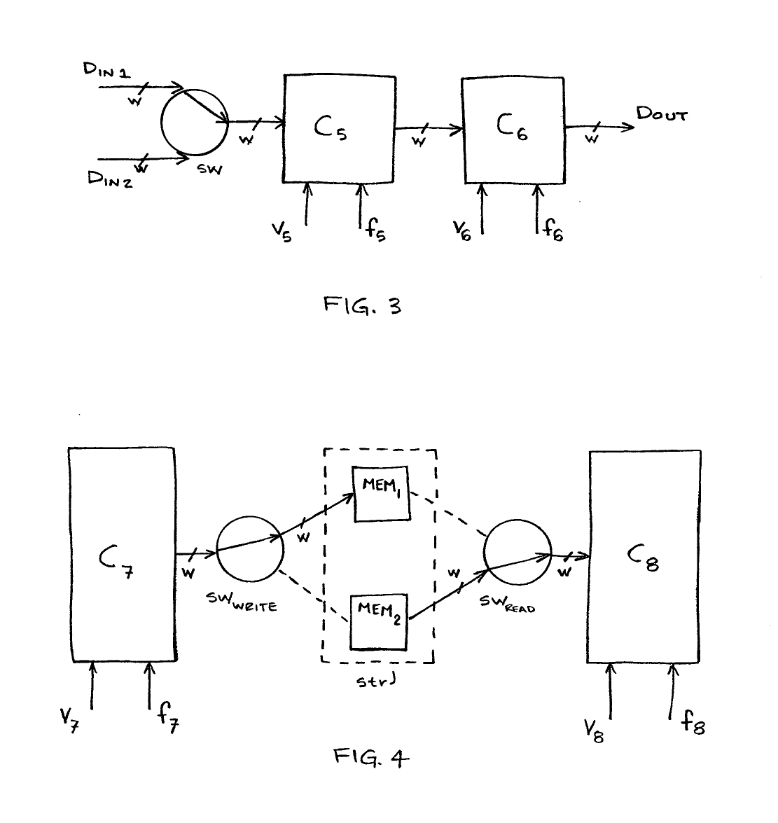

FIG. 4 shows the use of a storage element str between two consecutive pipeline stages, C₇ and C₈. The storage element str allocates two memory spaces mem₁, mem₂. The use of the two memory spaces mem₁, mem₂ accessed using associated write sw_{write} and read sw_{read} functions allows each pipeline stage C₇, C₈ to work independently of the other. Each write/read function sw_{write}, sw_{read} can be a functional equivalent of a single-pole double-throw switch, having one pole that can throw or make electrical contact with two separate stationary contacts such as an addressing function of the storage element str, an addressing function of a multiple input port—multiple output port static RAM, a memory space access device, a latch, and the like. The write/read function sw_{write}, sw_{read} equivalents can switch one or a plurality of data lines w depending if the data path is serial or parallel to each memory space mem₁, mem₂ memory content location. The memory spaces mem₁, mem₂ in the storage element str are accessed independently, in an exclusive or arrangement by the write/read functions sw_{write}, sw_{read} allowing for a write function sw_{write} to “write to” either memory space, and a read function sw_{read} to “read from” either memory space. The “writing to” and “reading from” functions can access the memory content locations of the memory spaces mem₁, mem₂ in any predetermined pattern. The memory spaces mem₁, mem₂ can have the same or different storage capacities.

Depending upon the access of the read function sw_{read}, storage element sir contents mem₁ or mem₂ can be read by stage C₈. Depending upon the access of the write function sw_{write}, storage element str contents mem₁ or mem₂ can be written to by stage C₇. In this example, the access of the write sw_{write} and read sw_{read} functions are controlled in opposite correspondence—one memory space mem₂ is read from while the other memory space mem₁ is written to.

Each stage C₇, C₈ can process data until it reads (stage C₈) all data (mem₂), or writes (stage C₇) all data (mem₁). The separation of stage operations using a storage element sir is desirable when different stages have to write or read data in different patterns. The storage capacity of a memory space is greater than or equal to the latency of a following stage. A classic, prior art pipeline implementation only permits sequential dataflow, i.e., the output of a stage is accessed in the same order by the input of a subsequent stage. The operating frequency of the storage elements sir is that of its associated stage. The voltage V₈ supplied to stage C₈ is set as low as possible, corresponding to the clock f₈ requirements of stage C₈, but greater than the hardware threshold voltage Vₜₕ of stage C₈. The voltage V₇ supplied to stage C₇ is then set as low as possible, corresponding to the clock f₇ requirements of stage C₇, but greater than the hardware threshold voltage Vₜₕ of stage C₇.

The advantage of the method of the invention is reduced power consumption. As discussed above, power has a quadratic relationship with voltage and a linear relationship with frequency. Power therefore has a cubic relationship with voltage and frequency together. If frequency and voltage are both halved, power consumption reduces by a factor of 8. Another advantage is the use of storage elements providing for high throughput.

The invention is used to optimally realize in hardware operationally complex computations. What follows is an example of a low-power, high-throughput hardware implementation of multi-stage digital signal transformations based upon the teachings of the invention. The example implements one of the more complex portions of JPEG 2000 image reconstruction—a 2-dimensional IDWT.

When reconstructing an image using a 2-dimensional IDWT, the amount of data increases with each successive level until the image is formed. To sustain the IDWT throughput, the hardware implementation requires resources that provide considerable storage, multipliers, and arithmetic logic units (ALUs). The method of the invention creates an efficient stream-based architecture employing polyphase reconstruction, multiple voltage levels, multiple clocked pipelines, and storage elements as will be described.

By way of background, the wavelet transform converts a time-domain signal to the frequency-domain. The wavelet analysis filters different frequency bands, and then sections each band into slices in time. Unlike a Fourier transform, the wavelet transform can provide time and location information of the frequencies, i.e., which frequency components exist at different time intervals. Image compression is achieved using a source encoder, a quantizer and an entropy encoder. Wavelet decomposition is the source encoder for image compression. Computation time for both the forward and inverse DWT is great and increases exponentially with signal size.

Wavelet analysis separates the smooth variations and details of an image by decomposing the image using a DWT into subband coefficients. The advantage of wavelet subband compression includes gain control for image softening and sharpening, and a scalable compressed data stream. Wavelet image processing keeps an image intact once it is compressed obviating distortions.

A typical digital image is represented as a two-dimensional array of pixels, with each pixel representing the brightness level at that point. In a color image, each pixel is a triplet of red, green and blue (RGB) subpixel intensities. The number of distinct colors that can be represented by a pixel depends on the color depth, i.e., the number of bits per pixel (bpp).

Images are transformed from an RGB color space to either a YCrCb or a reversible component transform (RCT) space leading to three components. After transformation, the image array can be processed.

A time-domain function f(t) can be expressed in terms of wavelets using the wavelet series

$$f ( t ) = {\sum }_{s} {\sum }_{τ} {a}_{s , τ} ψ ( s , τ , t ) dt , \qquad ( 3 )$$

where ψ(S, τ, t) represents the different wavelets obtained from the “mother wavelet” ψ, and S indicates dilations of the wavelet. A large S indicates a wide wavelet that can extract low frequency components when convolved with the input signal, while a small S indicates a narrow wavelet that can extract high frequency components. τ represents different translations of the mother wavelet in time and is used to extract frequency components at different time intervals of the input signal.

The coefficients a_{s,τ} of the wavelets are found using

$${a}_{s , τ} = {\int }_{- ∞}^{∞} f ( t ) ψ ( s , τ , t ) ⅆ t . \qquad ( 4 )$$

The discrete wavelet transform applies the wavelet transform to a discrete-time signal x(n) of finite length having N components. Filter banks are used to approximate the behavior of a continuous wavelet transform. Subband coefficients are found using a series of filtering operations.

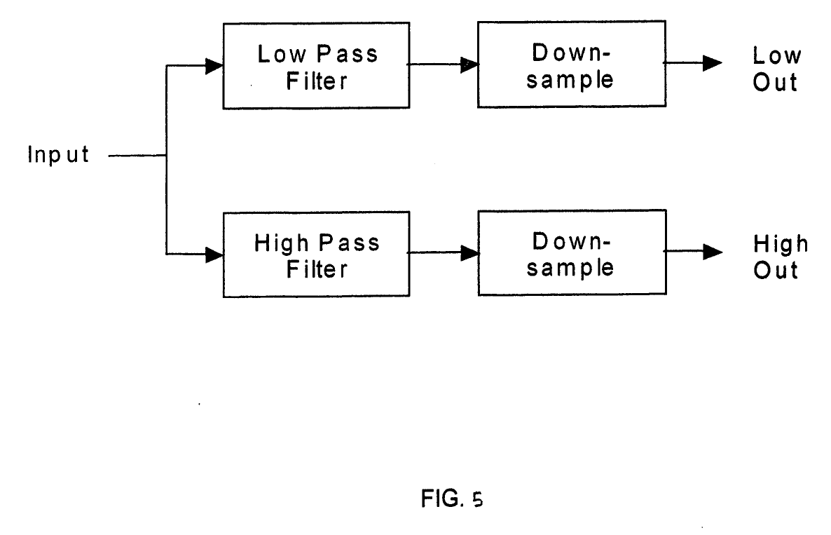

Wavelet decomposition—applying a DWT in a forward direction—is performed using two-channel analysis filters where the signal is decomposed using a pair of filters, a half band low pass filter and a half band high pass filter, into high and low frequency components followed by down-sampling. A forward DWT is shown in FIG. 5.

Filtering a signal in the digital domain corresponds to the mathematical operation of convolution, where the signal is convolved with the impulse response of the filter. The half band low pass filter removes all frequencies that are above half of the highest frequency in the signal. The half band high pass filter removes all frequencies that are below half of the highest frequency in the signal. The low-frequency component usually contains most of the frequency of the signal and is referred to as the approximation. The high-frequency component contains the details of the signal.

Most natural images have smooth color variations with fine details represented as sharp edges in between the smooth variations. The smooth variations in color can be referred to as low frequency variations and the sharp variations as high frequency variations. The low frequency components constitute the base of an image, and the high frequency components add upon them to refine the image giving detail.

For image processing, digital high and low pass filters are commonly employed in the DWT and DCT processes as one or two-dimensional filters. One-dimensional filters operate on a serial stream of data, whereas two-dimensional filters comprise two one-dimensional filters that alternately operate on the data stream and its transpose.

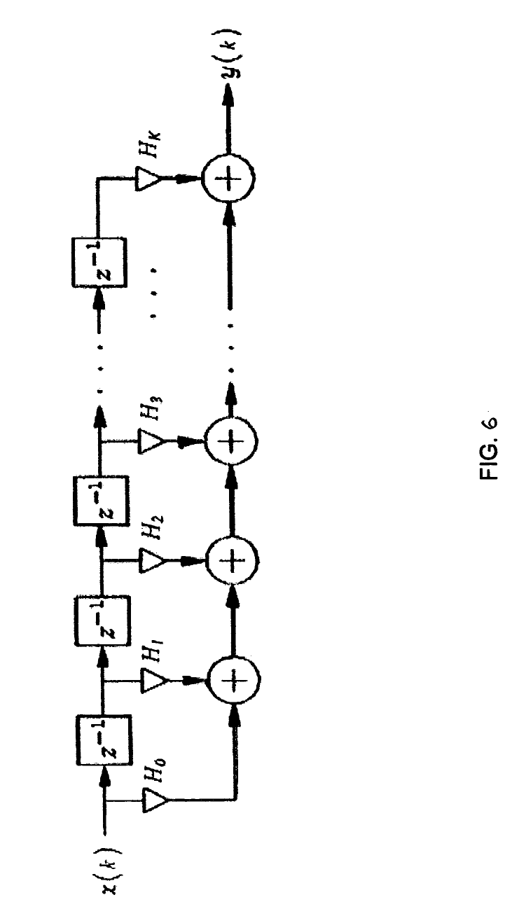

The filters used for decomposition are typically transverse digital filters as shown in FIG. 6. Transverse filters can be implemented using a weighted average. Filtering involves convolving the filter coefficients with the input signal, or stream of pixels
y[k]=Σ_{i=-∞}^{i=∞}H[i].x[k−i]=Σᵢ₌₀^{i=K}H[i].x[k−i], (5)

where H₀, H₁, H₂, H₃, . . . Hₖ are predefined filter coefficients or weights and z⁻¹ are shift register positions temporarily storing incoming values. With each new value, the filter calculates an output value for a given instant in time by observing the input values surrounding that instant of time. As a new value arrives, the shift register values are displaced discarding the oldest value. The process consists of multiplying each input value by the filter weights which define the filtering action. By adjusting the weights, a low pass or a high pass filter can be obtained. Since the filters employed are half band low pass and half band high pass filters, the filter architectures are the same for each level of decomposition.

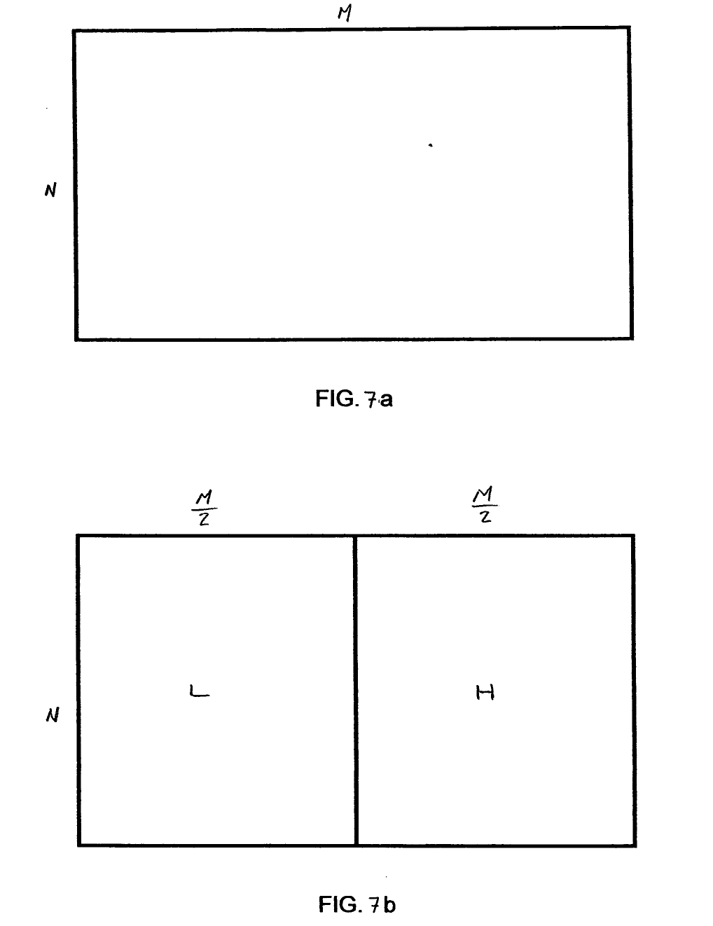

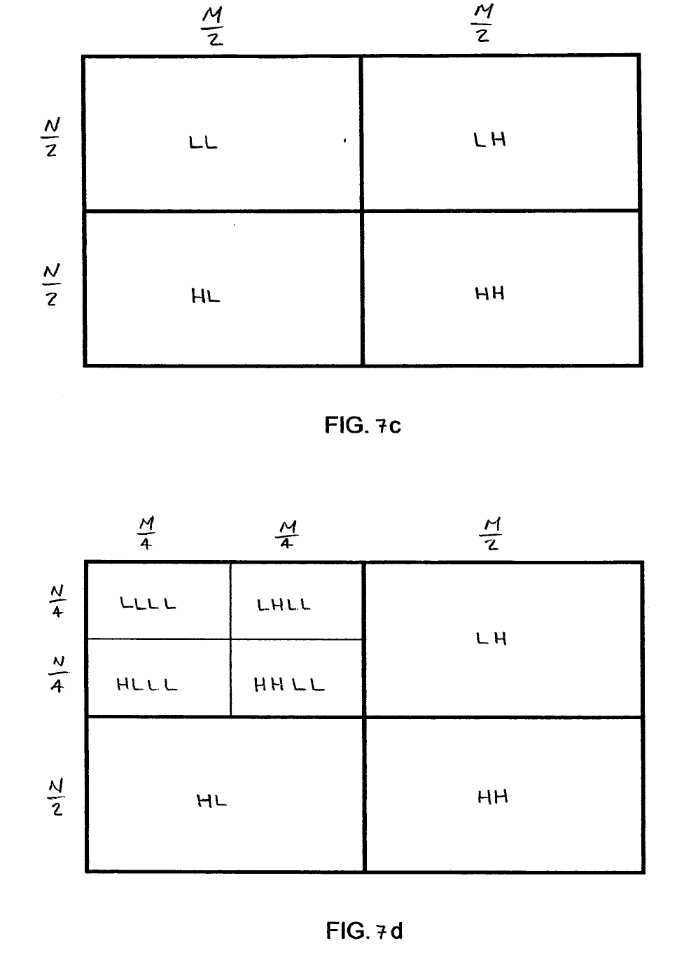

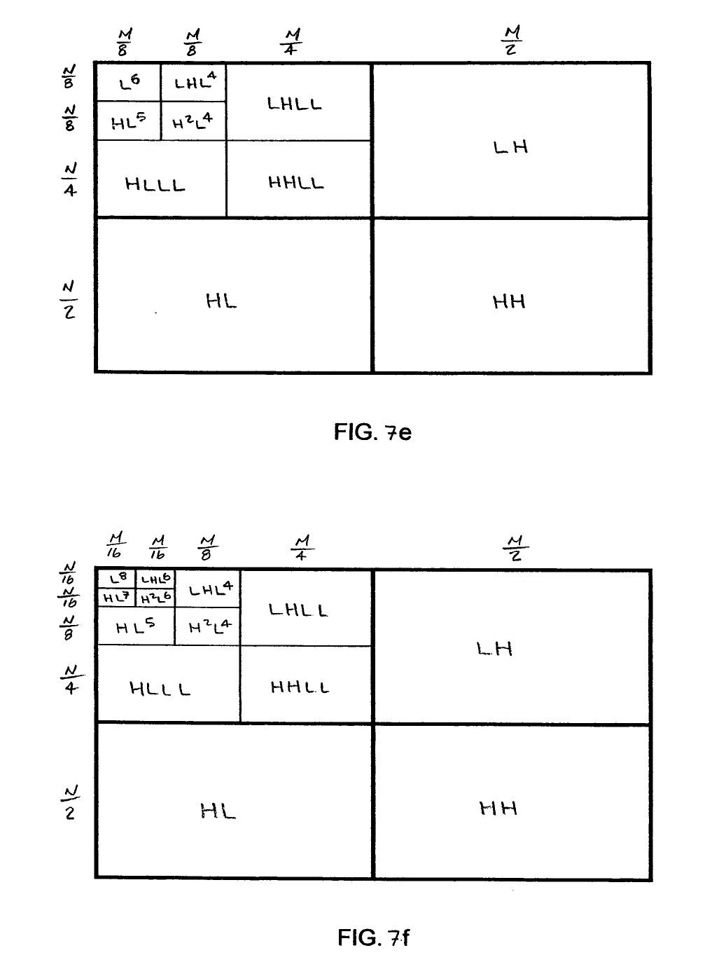

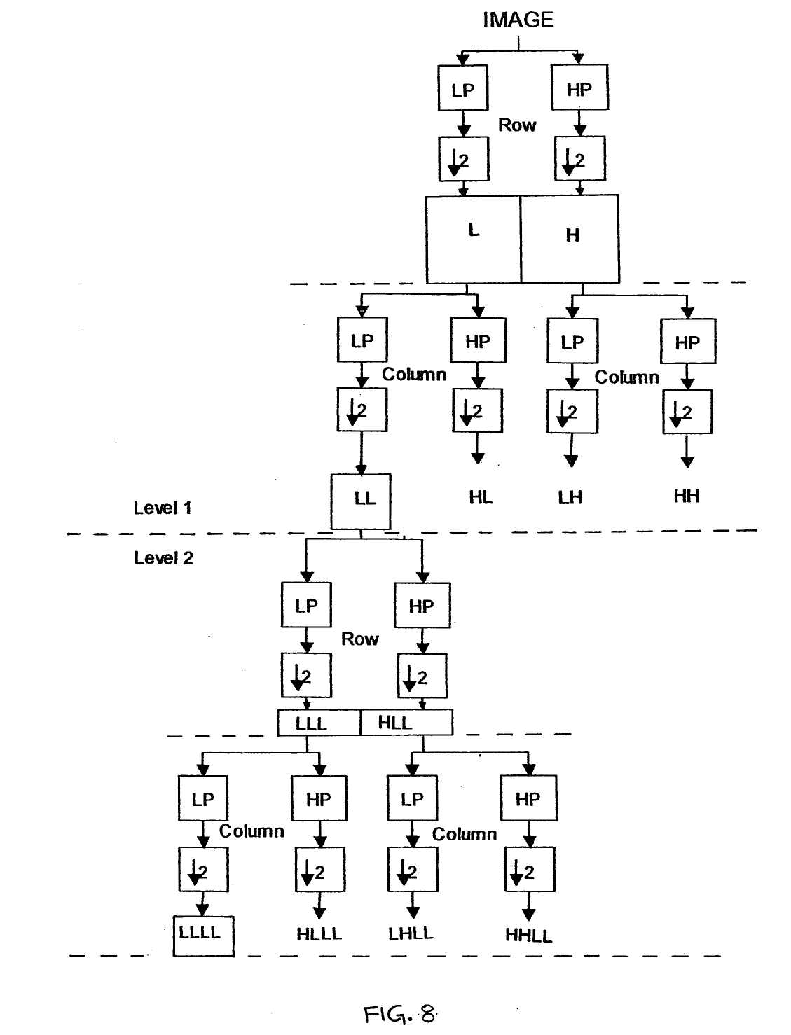

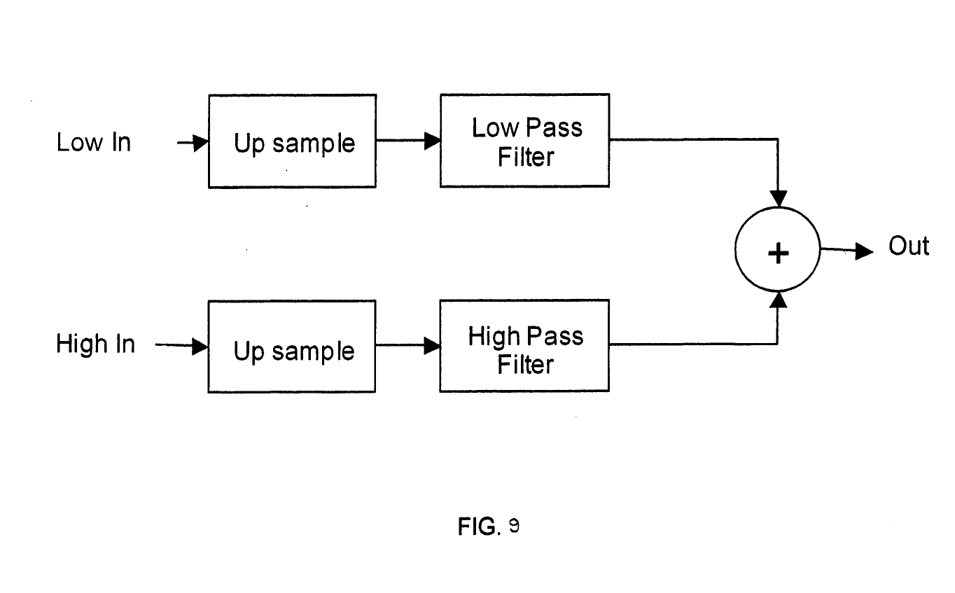

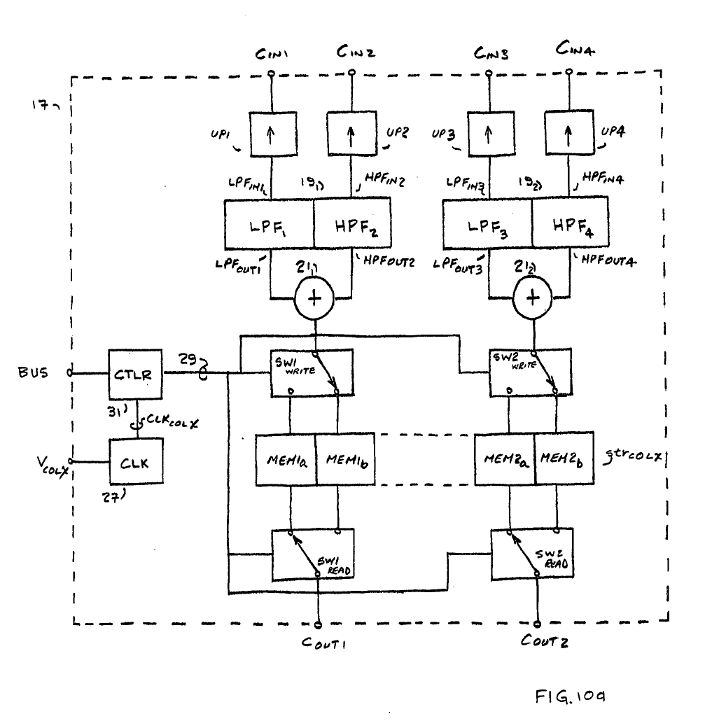

Decomposition of an N×M color space is performed in levels with each level performing a row-by-row (N) and a column-by-column (M) analysis. This type of wavelet decomposition is referred to as a 2-dimensional DWT, an example where N<M is shown in FIGS. 7a-7f. Each N row contains M pixels, with each pixel typically having three color space multi-bit values. Decomposition is performed for each color space value. In image processing, the input signal is not a time-domain signal, but pixels distributed in space.

Each row of pixels (sub pixel) is low and high pass filtered. After filtering, half of the samples can be eliminated or down-sampled, yielding two

$$N \times \frac{M}{2}$$

images referred to as L (low) and H (high) row subband coefficients. The intermediate results are indexed as an array in memory as shown in FIG. 7b.

The Nyquist theorem states that the minimum number of discrete samples to perfectly reconstruct a signal is twice the maximum frequency component of the signal. Therefore, if a half band low pass filter, which removes all frequency components larger than the median frequency, is applied to a signal, every other sample in the output can be discarded. Discarding every other sample subsamples the signal by two whereby the signal will have half the number of discrete samples effectively doubling the scale. A variation of the theorem makes down-sampling applicable for a high pass filter that removes all frequency components smaller than the median frequency.

Decomposition halves the time resolution since half of the number of samples characterizes the entire signal. However, the operation doubles the frequency resolution since the frequency band of the signal now spans only half the previous frequency band, effectively reducing the uncertainty in the frequency by half. This is referred to as subband coding.

From the data store, each column (M) of coefficients is low and high pass filtered, down-sampled, and stored yielding four

$$\frac{N}{2} \times \frac{M}{2}$$

sub images as shown in FIG. 7c. The four sub images are the resultant coefficients of a one level, 2-dimensional decomposition. Of the four sub images obtained, the image obtained by low pass filtering the columns and rows is referred to as the LL (column low, row low) sub image. The image obtained by high pass filtering the columns and low pass filtering the rows is referred to as the HL (column high, row low) sub image. The image obtained by low pass filtering the columns and high pass filtering the rows is referred to as the LH (column low, row high) sub image. And the image obtained by high pass filtering the columns and rows is referred to as the HH (column high, row high) sub image. Each sub image obtained can then be filtered and subsampled to obtain four more sub images. This process can be continued for a desired subband structure. A subband is a set of real number coefficients which represent aspects of the image associated with a certain frequency range as well as a spatial area of the image. The result is a collection of subbands which represent several approximation scales.

JPEG 2000 supports pyramid decomposition. Pyramid decomposition only decomposes the LL sub image in subsequent levels, each leading to four more sub images as shown in FIGS. 7d-7f. FIG. 7d shows a two level decomposition producing second level subbands L⁴, HL³, LHL² and H²L². FIG. 7e shows a three level decomposition producing third level subbands L⁶, HL⁵, LHL⁴ and H²L⁴. FIG. 7f shows a four level decomposition producing fourth level subbands L⁸, HL⁷, LHL⁶ and H²L⁶. At this level, the L⁸ subband coefficients occupy

$$\frac{N}{16} \times \frac{M}{16}$$

of the original image space. A fifth level decomposition would produce fifth level subbands L¹⁰, HL⁹, LHL⁸ and H²L⁸ (not shown). The subbands for a five level decomposition of one video frame are: L¹⁰, HL⁹, LHL⁸, H²L⁸; HL⁷, LHL⁶, H²L⁶; HL⁵, LHL⁴, H²L⁴; HL³, LHL², H²L²; HL, LH and HH.

Shown in FIG. 8 is the data flow for the two level, 2-dimensional forward DWT producing FIG. 7d. Each level of decomposition reduces the image resolution by a factor of two in each dimension. Each row process uses one analysis filter pair and each column process uses two analysis filter pairs. All of the subband coefficients represent the same image, but correspond to different frequency bands. The LL subband at the highest level contains the most information while the other detail bands contain relatively less information—image details such as sharp edges.

The forward DWT analyzes the image data producing a series of subband coefficients. Rather than discarding some of the subband information and losing detail, all subband coefficients are kept and compression results from subsequent subband quantization and the compression scheme used in the entropy encoder. The quantizer reduces the precision of the values generated from the encoder reducing the number of bits required to save the transform coefficients.

Reconstruction of the original image is performed in reverse; by entropy decoding, inverse quantization, and source decoding—the later performing the DWT in an inverse direction as shown in FIG. 9. The forward DWT separates image data into various classes of importance; the IDWT reconstructs the various classes of data back into the image.

A filter pair comprising high and low pass filters is used and is referred to as a synthesis filter. The inverse process begins using the subband coefficients output from the last level of a forward DWT, applying the filters column wise and then row wise for each level, with the number of levels corresponding to the number of levels used in the forward DWT until image reconstruction is complete. The inputs at each level of reconstruction are subband coefficients.

The IDWT can be implemented as a pipelined data path. Owing to up-sampling, successive stages of the pipeline operate on progressively higher amounts of data. For an N×M image, the last level of reconstruction operates on four subbands, each of size

$$\frac{N}{2} \times \frac{M}{2} .$$

The four subbands of the preceding level are

$$\frac{N}{4} \times \frac{M}{4} .$$

The input to each level of the IDWT consists of four subbands and the final output is an N×M image. Each level consists of column and row processing. The column stage which includes up-sampling produces two subbands. These subbands are row processed which includes up-sampling to produce another subband. For a given level of reconstruction, the rows cannot be processed until all of the columns are processed. For a high throughput, the row and column stages must be able to operate independently of each other to ensure continuous data flow.

Using the method of the invention shown in FIGS. 2a-2b to implement an IDWT for a particular image resolution, the entire IDWT is analyzed and a performance requirement is established (steps 101, 103). For this example, a five level IDWT is to be implemented complementing the forward DWT described above. The overall computation is synthesized (step 105) into a plurality of levels (n=5), with each level comprising a column and a row stage. The column stage comprises two reconstruction channels; the row stage one reconstruction channel. Each reconstruction channel (FIG. 9) comprises two up-samplers coupled to a synthesis filter and an adder providing a subband coefficient (summed filter) output. The fifth level subband coefficients output from the forward DWT are ultimately input at the n^{th}-level (5^{th} level) of the IDWT. Three subband coefficients are input at each subsequent level. The last level (1^{st} level) outputs the image.

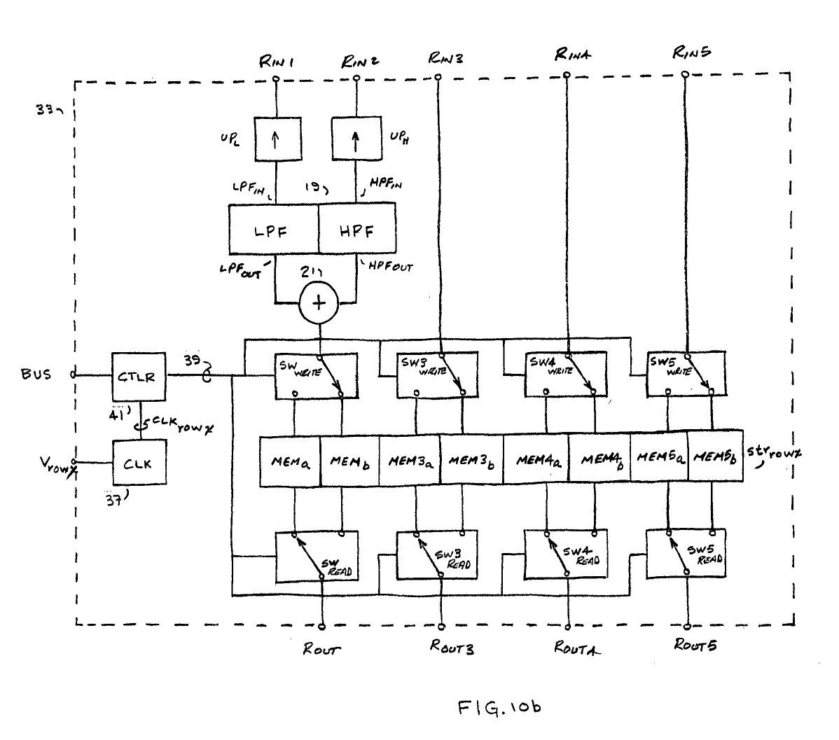

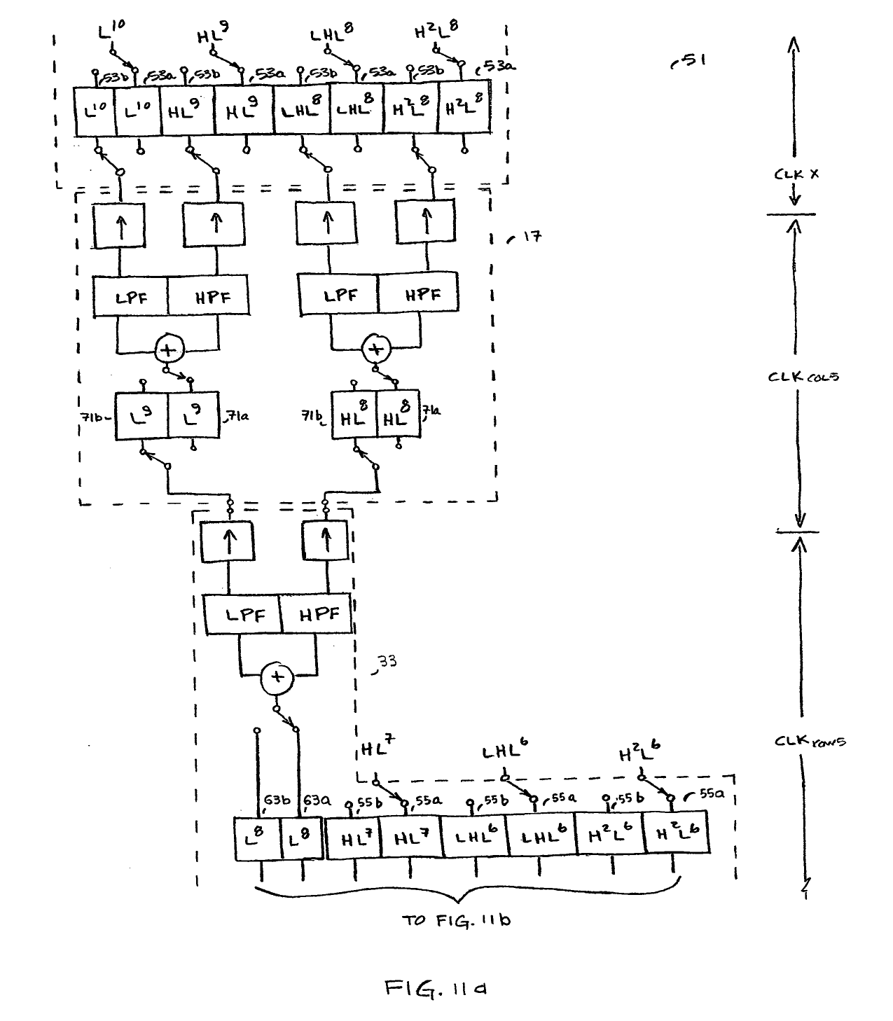

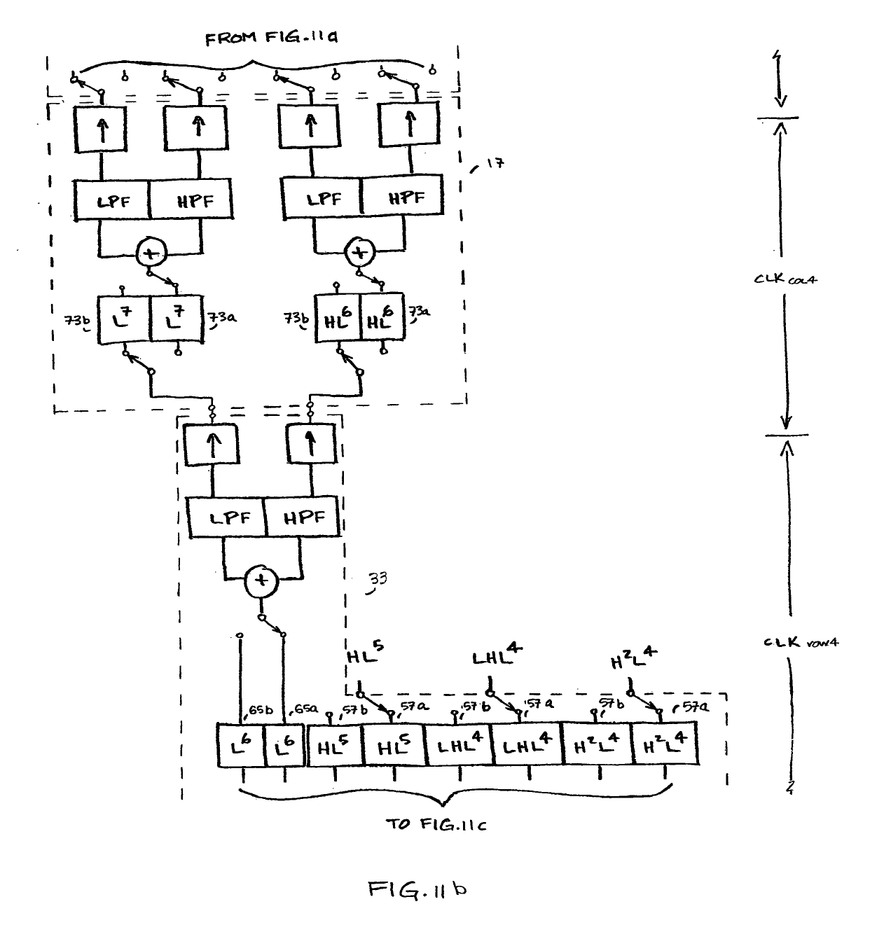

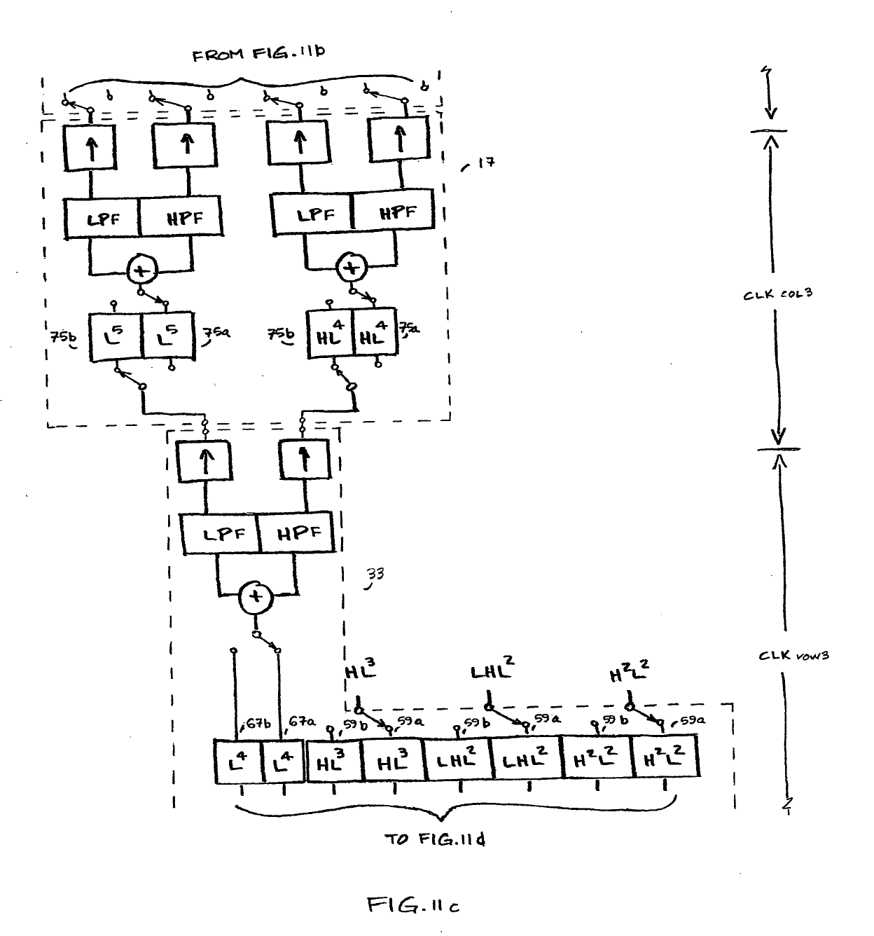

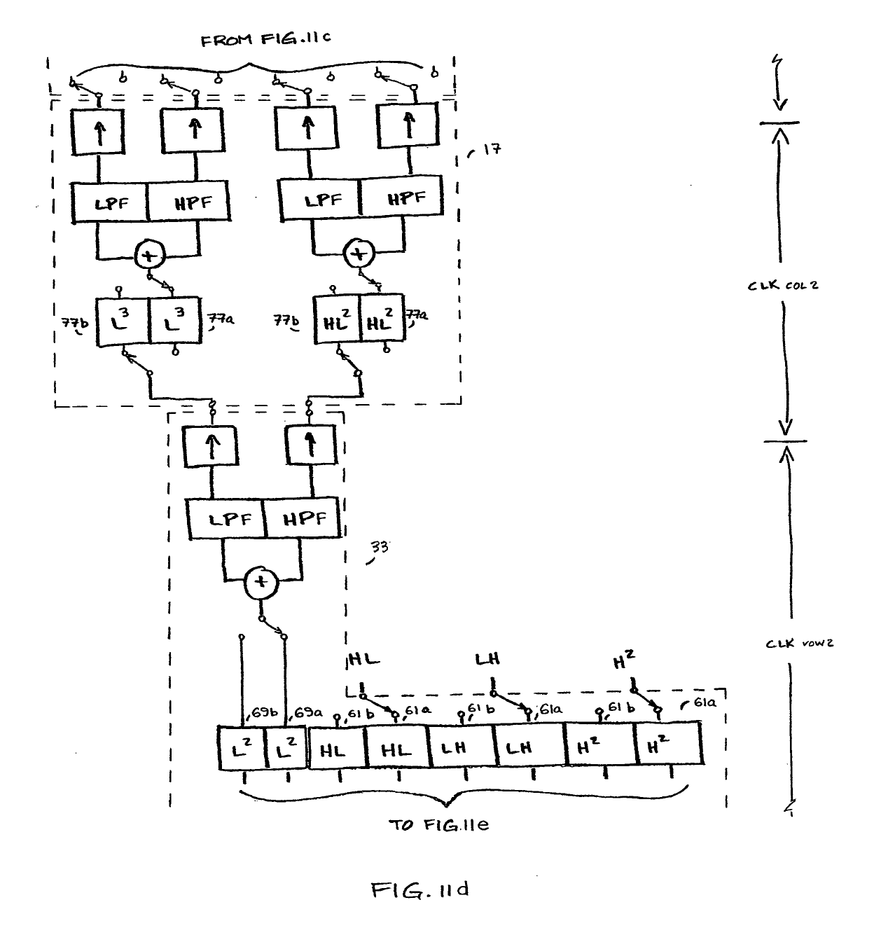

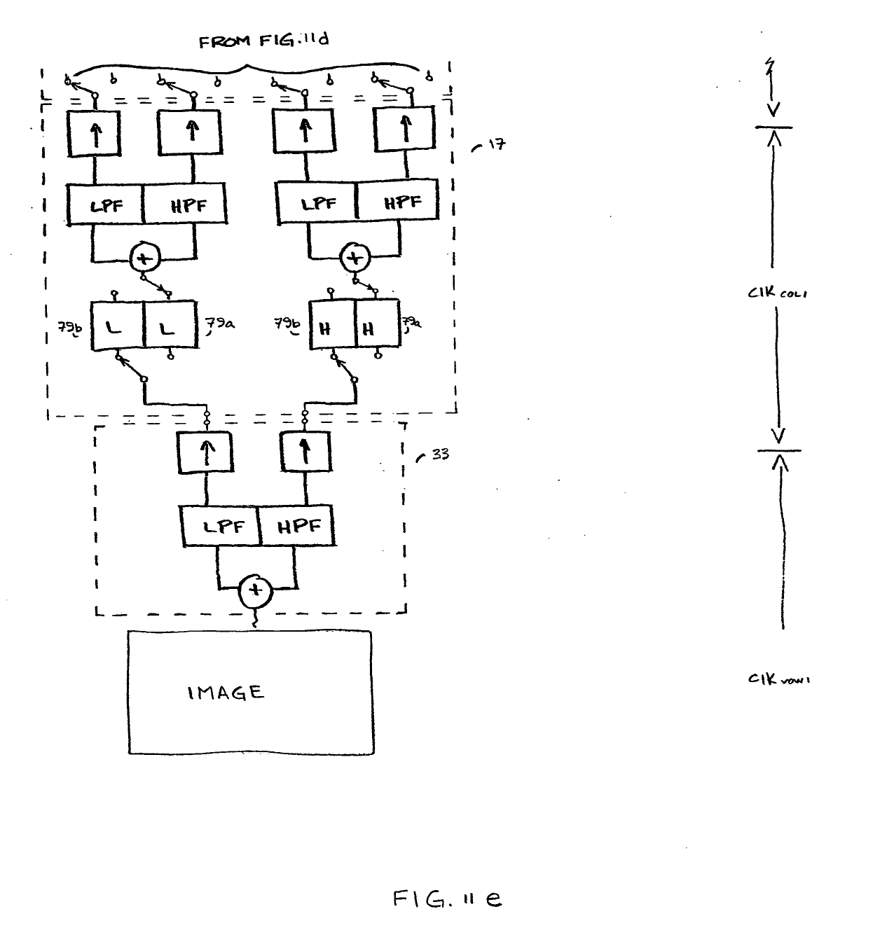

From the synthesis step (step 105) one stage is produced for column processing 17 and another stage is produced for row processing 33 as shown in FIGS. 10a and 10b respectively. The operations used in each stage are translated (step 107) into a hardware equivalent. As one skilled in the art will appreciate, the data paths show in FIGS. 10a, 10b, and 11a-11e can be serial (w=1) or parallel (w=2, 3, . . . n) data lines. Storage elements comprising allocated memory spaces (steps 109, 111) are employed between column and row processing. For each memory space within a storage element, one space is written to while the other space is read from, keeping the pipeline filled. Once each memory space write/read is completed, the memory space pair is exchanged, allowing for continuous data flow. The entire pipeline is choreographed such that every register in every function in every stage of the pipeline is filled, and with each clock cycle, data is moved forward with no stalling. Each stage 17, 33 has its own predetermined clock frequency clk_{colx}, clk_{rowx} (step 115).

FIG. 10a shows the column processing stage 17 derived for each level of the IDWT according to the teachings of the invention. The column processing stage 17 comprises two reconstruction channels having four inputs cᵢₙ₁, cᵢₙ₂, cᵢₙ₃, cᵢₙ₄, four up-samplers up₁, up₂, up₃, up₄, each coupled to an input, the up-sampler outputs coupled to two synthesis filters 19₁, 19₂ each synthesis filter comprising a low LPF₁, LPF₃ and a high HPF₂, HPF₄ pass filter, each filter having an input LPFᵢₙ₁, HPFᵢₙ₂, LPFᵢₙ₃, HPFᵢₙ₄ coupled to a respective up-sampler up₁, up₂, up₃, up₄. Each synthesis filter pair 19₁, 19₂ output LPFₒᵤₜ₁, HPFₒᵤₜ₂, LPFₒᵤₜ₃, HPFₒᵤₜ₄ is coupled to an adder 21₁, 21₂. Each adder 21₁, 21₂ output is coupled to a storage element str_{col} write function sw1_{write}.

As described above, each storage element str_{col} allocates memory spaces for storing data output from an upstream computation, while allowing a downstream computation to read previously written data in any pattern. For each pair of memory spaces, write/read functions are used to direct data exclusively to and from each memory space for simultaneous writing and reading, allowing upstream and downstream computation stages to function independently.

The storage element str_{col} for the column stage 17 has two pairs of allocated memory spaces mem1ₐ, mem1_{b}, mem2ₐ, mem2_{b} accessed by write/read functions sw1_{write}, sw1_{read}, sw2_{write}, sw2_{read}. The common pole of the write function sw1_{write} is coupled to the output of the first channel adder 21₁. The common pole of the write function sw2_{write} is coupled to the output of the second channel adder 21₂. The common pole of the two read functions sw1_{read}, sw2_{read} are coupled to stage outputs cₒᵤₜ₁, cₒᵤₜ₂. The column IDWT stage 17 is used in conjunction with the row IDWT stage 33 for 2-dimensional IDWT, n level reconstruction.

A voltage input Vcolₓ provides operating voltage for the column x stage 17 based upon clock 27 frequency. A controller 31 accepts an image information signal setting forth the size of the image, frame rate, color depth (bpp), level of reconstruction known a priori from a common bus BUS coupling all stages in all levels and controls the switching action of the storage element str_{col} write/read functions over line 29. The image information is obtained either from an external control such as a user configurable setting, or more advantageously, decoded upstream prior to entropy decoding in the incoming data stream header. A maximum image size determines the required storage element capacity for each column 17 and row 33 stage. Image sizes less than the maximum can be processed. Each smaller image size has a correspondingly smaller memory footprint in the allocated memory spaces. The image information changes each storage element memory space access write/read function pattern for each image size.

FIG. 10b shows the row processing stage 33 derived for each level of the IDWT according to the teachings of the invention. The row processing stage 33 comprises one reconstruction channel and five inputs rᵢₙ₁, rᵢₙ₂, rᵢₙ₃, rᵢₙ₄, rᵢₙ₅, two up-samplers up_{L}, up_{H}, coupled to inputs rᵢₙ₁, rᵢₙ₂, the up-sampler outputs coupled to a synthesis filter 19 comprising a low LPF and a high HPF pass filter, each filter having an input LPFᵢₙ, HPFᵢₙ coupled to a respective up-sampler up_{L}, up_{H}, and an output LPFₒᵤₜ, HPFₒᵤₜ coupled to the reconstruction channel adder 21. The adder 21 output is coupled to a storage element str_{row} write function sw_{write}.

The storage element str_{row} for the row stage 33 has four pairs of allocated memory spaces memₐ, mem_{b}, mem3ₐ, mem3_{b}, mem4ₐ, mem4_{b}, mem5ₐ, mem5_{b} accessed by four write/read functions sw_{write}, sw_{read}, sw3_{write}, sw3_{read}, sw4_{write}, sw4_{read}, sw5_{write}, sw5_{read}. Write function sw_{write} is coupled to the output of the adder 21. The three remaining write functions sw3_{write}, sw4_{write}, sw5_{write} are coupled to stage inputs rᵢₙ₃, rᵢₙ₄, rᵢₙ₅ to receive subband coefficients available and waiting to be processed. The four read functions sw_{read}, sw3_{read}, sw4_{read}, sw5_{read} couple to row stage outputs rₒᵤₜ, rₒᵤₜ₃, rₒᵤₜ₄, rₒᵤₜ₅.

A voltage input Vrowₓ provides operating voltage for the row x stage 33 based upon clock 37 frequency. A controller 41 accepts a signal setting forth the size of the image, color depth (bpp) and level of reconstruction, known a priori, from a common bus BUS and controls the switching action of the storage element str_{row} write/read functions over line 39. The row processing stage 33 for the last level is simplified needing only the reconstruction channel.

FIGS. 11a-11e. show a five level IDWT using the column 17 and row 33 stages. The beginning of the inverse transform is the fifth level as shown in FIG. 11a. The fifth level column stage clock frequency clk_{col5} is the slowest. Each subsequent stage processes twice as much data as the one before, requiring double the clock frequency. The voltage of each subsequent stage must increase for maximum power efficiency, or can be set at any level as long as the hardware voltage threshold Vₜₕ for the respective level is met. The voltage Vcolₓ of each column stage 17 can be approximately half the voltage Vrowₓ of each row stage 33 for a given level.

By knowing the reconstructed image size, bpp and number of levels of reconstruction; the column str_{col5}, str_{col4}, str_{col3}, str_{col2}, str_{col1} and row Str_{row5}, Str_{row4}, Str_{row3}, str_{row2} storage element memory spaces, clock frequencies clk_{col5}, clk_{row5}, clk_{col4}, Clk_{row4}, clk_{col3}, clk_{row3}, clk_{col2}, clk_{row2}, clk_{col1}, clk_{row1} and stage voltages V_{col5}, V_{row5}, V_{col4}, V_{row4}, V_{col3}, V_{row3}, V_{col2}, V_{row2}, V_{col1}, V_{row1} and can be determined.

Continuing with the example, for real-time reconstruction of one color plane of a moving picture having an image resolution of 1024(2¹⁰)×2048(2¹¹) pixels (i.e., sub pixels) at a frame rate of 48 frames per second, wavelet reconstruction of the 1024(N)×2048(M) color space would assemble an image having 2,097,152 pixels, requiring the source decoder (IDWT) to process 100,663,296 pixels per second with each pixel having an associated color depth. For this example, each pixel has a 16 bit value. The larger the color depth, the more storage element memory required. The clock rate supporting real-time reconstruction would be ˜9.9 ns per pixel or ˜101 MHz at the output of the last (1^{st}) level (step 115).

For moving images having a frame rate of 48 fps, each frame of the moving image is processed for display every 0.0208 seconds. For the five level IDWT 51 shown in FIGS. 11a-11e, the clock frequency of the level 1 row stage Clk_{row1} must process each pixel at ˜101 MHz. As described above, each subsequent stage in an IDWT operates at twice the frequency of the previous stage. Each previous stage operates slower. In inverse order, clk_{col1}=50.5 MHz; clk_{row2}=25.3 MHz, clk_{col2}=12.6 MHz, clk_{row3}=6.3 MHz, clk_{col3}=3.16 MHz, Clk_{row4}=1.58 MHz, clk_{col4}=789 kHz, Clk_{row5}=395 kHz, clk_{col5}=197 kHz, and clkₓ=98,600 Hz (steps 117, 119).

The last step of the invention is assigning operating voltages (steps 121, 123) to each stage in the pipeline 51. The ten stage voltages V_{col5}, V_{row5}, V_{col4}, V_{row4}, V_{col3}, V_{row3}, V_{col2}, V_{row2}, V_{col1}, V_{row1} can be determined since each stage voltage is proportional with the stage operating frequency. Each stage voltage must be greater than the threshold voltage Vₜₕ of the respective stage hardware. A theoretical value can be approximated for each stage threshold voltage Vₜₕ or obtained empirically. For the streaming computation to have maximum power efficiency, the stage in the pipeline having the fastest clock frequency clk_{row1} will typically have the highest voltage V_{row1} and the stage having the slowest clock frequency clk_{col5} will have the lowest voltage level V_{col5}. The stage voltages residing between the maximum V_{row1} and minimum V_{col5} vary accordingly V_{row5}, V_{col4}, V_{row4}, V_{col3}, V_{row3}, V_{col2}, V_{row2}, V_{col1}. Alternatively, each stage voltage in the pipeline can have the same value, or at least one or more different values, so long as the voltage threshold requirement for each stage is met.

After entropy decoding, inverse quantization and removal of any header information is complete, the subband pixel coefficients for each frame of the one color plane enter the source decoder 51 at a clock clkₓ rate of 98,600 Hz.

FIGS. 11a-11d shows an incoming frame subband coefficient data stream L¹⁰, HL⁹, LHL⁸, H²L⁸; HL⁷, LHL⁶, H²L⁶; HL⁵, LHL⁴, H²L⁴; HL³, LHL², H²L²; HL, LH and HH, and their respective storage element memory spaces 53a, 53b, 55a, 55b, 57a, 57b, 59a, 59b, 61a, 61b. Each storage element memory space alternately stores subband coefficients for one incoming frame for reconstruction. For this example, the incoming frame subband coefficients would be continuously written 48 times per second in alternate a, b memory spaces of the incoming frame 53a, 53b, and fifth 55a, 55b, fourth 57a, 57b, third 59a, 59b, and second 61a, 61b level row storage elements str_{rowx}. The fifth level subband coefficients L¹⁰, HL⁹, LHL⁸, H²L⁸, fourth level subband coefficients HL⁷, LHL⁶, H²L⁶, third level subband coefficients HL⁵, LHL⁴, H²L⁴, second level subband coefficients HL³, LHL², H²L² and first level subband coefficients HL, LH and HH for frame 1 are written into one of the memory spaces (a) of the storage elements, completing all subband coefficients for one frame. The coefficients arrive in time for each level of reconstruction. A discussion of inverse quantization which controls the incoming subband coefficients is beyond the scope of this disclosure. The process continues by writing the fifth level subband coefficients L¹⁰, HL⁹, LHL⁸, H²L⁸ for the next frame (2) into the other memory space (b) of the incoming frame storage element 53.

As can be seen in FIG. 11a, fifth level reconstruction for frame 1 can commence as soon as fifth level subband coefficients L¹⁰, HL⁹, LHL⁸, H²L⁸ are written into incoming frame storage element 53 memory space 53a. The processing rate for the column stage clk_{col5} is 197 kHz. The fourth level subband coefficients HL⁷, LHL⁶, H²L⁶ are written into fifth level row storage element 55 memory spaces 55a at the clk_{row5} clock rate. The output of the fifth level, L⁸, is written into a first memory space 63a of the fifth level row storage element with fourth level subband coefficients HL⁷, LHL⁶, and H²L⁶ for fourth level processing.

Fourth level reconstruction (FIG. 11b) commences and the outputs are computed at the clk_{col4} clock rate. The third level subband coefficients HL⁵, LHL⁴, H²L⁴ are written into fourth level row storage element 57 memory spaces 57a at the clk_{row4} clock rate. The output of the fourth level, L⁶, is written into one memory space 65a of the fourth level row storage element with third level subband coefficients HL⁵, LHL⁴, and H²L⁴ for third level processing.

Third level reconstruction (FIG. 11c) commences and is performed at the clk_{col3} clock rate. The second level subband coefficients HL³, LHL², H²L² are written into third level row storage element 59 memory spaces 59a at the clk_{row3} clock rate. The output of the third level, L⁴, is written into one memory space 67a of the third level row storage element with second level subband coefficients HL³, LHL², and H²L² for second level processing.

Second level reconstruction (FIG. 11d) can commence and is performed at the clk_{col2} clock rate. The first level subband coefficients HL, LH and HH are written into second level row storage element 61 memory spaces 61a at the clk_{row2} clock rate. The output of the second level, L², is written into one memory space 69a of the second level row storage element with first level subband coefficients HL, LH and HH for first level processing.

First level reconstruction (FIG. 11e) can commence and is performed at the clk_{col1} clock rate. The output of the first level is a one color plane reconstruction of the 1024(N)×2048(M) image.

The entire five level IDWT 51 is filled and busy, with each stage of each level processing coefficients belonging to a subsequent frame. Column 17 and row 33 stages of each level of the IDWT 51 contain storage elements str_{colx}, str_{rowx} for allocating memory spaces memₐ, mem_{b} for the fifth level 71a, 71b, 63a, 63b, 55a, 55b, fourth level 73a, 73b, 65a, 65b, 57a, 57b, third level 75a, 75b, 67a, 67b, 59a, 59b, second level 77a, 77b, 69a, 69b, 61a, 61b, and first level 79a, 79b, for holding the results of column processing 17 before row processing 33 and allowing the row processing stages 33 to access the memory spaces in a transpose read.

The fifth level subband coefficients L¹⁰, HL⁹, LHL⁸ and H²L⁸ each comprise 32×64 values (FIG. 11a). For a color depth of 16 bpp, the memory required for one memory space 53a of the incoming frame storage element 53 would be 32,768 bits, or 4,096 bytes for all coefficients of one subband. Since there are four subbands L¹⁰, HL⁹, LHL⁸ and H²L⁸, and the invention allocates two memory spaces for coefficients of each subband, the total subband coefficient memory required for the fifth level incoming frame storage element 53 is approximately (4,096 bytes)×(4 subbands)×(2 memory spaces)≅32 KB.

The four subbands L¹⁰, HL⁹, LHL⁸ and H²L⁸ are read by column, up-sampled up₁, up₂, up₃, up₄ by inserting a zero between each coefficient, and low pass and high pass filtered using the two synthesis filters 19₁, 19₂. Up-sampling increases the clock rate by a factor of two, transitioning from 98,600 Hz (clkₓ) to 197 kHz (clk_{col5}). The synthesis filter 19₁, 19₂ outputs are summed 21₁, 21₂ forming two subbands L⁹ and HL⁸ each comprising 64×64 coefficients which are written into a fifth level column storage element 71. The memory required would be 65,536 bits, or 8,192 bytes for all coefficients of one subband. Since there are two subbands L⁹ and HL⁸, and two memory spaces are employed, the total subband memory required for the fifth level row storage element 71 is approximately (8,192 bytes)×(2 subbands)×(2 memory spaces)≅32 KB.

The coefficients of subbands L⁹ and HL⁸ are read by rows in a row stage 33, up-sampled up_{L}, up_{H}, and low pass and high pass filtered using one synthesis filter 19. The 197 kHz clock rate (clk_{col5}) transitions to 395 kHz (clk_{row5}). The values are summed 21 forming subband coefficients L⁸ and are written into a fourth level row storage element 63, 55.

The amount of memory required to store subband coefficients for each level of the IDWT progressively increases by a factor of four. The fourth level subbands L⁸, HL⁷, LHL⁶ and H²L⁶ each comprise 64×128 coefficients. For a sixteen bit color depth, 131,072 bits or 16,384 bytes are required. Using two memory spaces, (16,384 bytes)×(4 subbands)×(2 memory spaces)≅131 KB are required.

At the fourth level, subbands L⁸, HL⁷, LHL⁶ and H²L⁶ are up-sampled and column 17 processed (FIG. 11b). The 395 kHz clock rate (clk_{row5}) transitions to 789 kHz (clk_{col4}). After column processing 17, subbands L⁷ and HL⁶ each comprising 128×128 coefficients are written into a fourth level column storage element 73 and are available for row processing 33. The memory required would be 262,144 bits, or 32,768 bytes for all coefficients of one subband. Since there are two subbands and two memory spaces are employed, the total subband memory required for the fourth level column storage element 73 is approximately (32,768 bytes)×(2 subbands)×(2 memory spaces)≅131 KB. After row processing 33, subband L⁶ coefficients are written into a third level row storage element 65, 57. The 789 kHz clock rate (clk_{col4}) transitions to 1.58 MHz (clk_{row4}). The third level subbands L⁶, HL⁵, LHL⁴ and H²L⁴ each comprise 128×256 coefficients. For a sixteen bit color depth, 524,288 bits or 65,536 bytes are required. Using two memory spaces 65a, 65b, 57a, 57b, (65,536 bytes)×(4 subbands)×(2 memory spaces)≅524 KB are required.

At the third level, subbands L⁶, HL⁵, LHL⁴ and H²L⁴ are up-sampled and column processed 17 (FIG. 11c). The 1.58 MHz clock rate (Clk_{row4}) transitions to 3.16 MHz (clk_{col3}). After column processing 17, subbands L⁵ and HL⁴ each comprising 256×256 coefficients are written into a third level column storage element 75 and are available for row processing 33. The memory required would be 1,048,576 bits, or 131,072 bytes for all coefficients of one subband. Since there are two subbands and two memory spaces are employed, the total subband memory required for the third level 75a, 75b is approximately (131,072 bytes)×(2 subbands)×(2 memory spaces)≅524 KB. After row processing 33, subband coefficients L⁴ are written into a third level row storage element 67, 59. The 3.16 MHz clock rate (clk_{col3}) transitions to 6.3 MHz (Clk_{row3}). The second level subbands L⁴, HL³, LHL² and H²L² each comprise 256×512 coefficients. For a sixteen bit color depth, 2,097,152 bits or 262,144 bytes are required. Using memory spaces 67a, 67b, 59a, 59b, (262,144 bytes)×(4 subbands)×(2 memory spaces)≅2 MB are required.

At the second level, subbands L⁴, HL³, LHL² and H²L² are column processed 17 (FIG. 1d). The 6.3 MHz clock rate (clk_{row3}) transitions to 12.6 MHz (clk_{col2}). After column processing 17, subbands L³ and HL² each comprising 512×512 coefficients are written into a second level column storage element 77 and are available for row processing 33. The memory required would be 4,194,304 bits, or 524,288 bytes for all coefficients of one subband. Since there are two subbands and memory spaces are employed, the total subband memory required for the second level column storage element 77 is approximately (524,288 bytes)×(2 subbands)×(2 memory spaces)≅2 MB. After row processing 33, subband coefficients L² are written into a second level row storage element 69, 61. The 12.6 MHz clock rate (clk_{col2}) transitions to 25.3 MHz (clk_{row2}). The first level subbands LL, HL, LH and HH each comprise 512×1024 values. For a sixteen bit color depth, 8,388,608 bits or 1,048,576 bytes are required. Using memory spaces 69a, 69b, 61a, 61b, (1,048,576 bytes)×(4 subbands)×(2 memory spaces)≅8 MB are required.

At the first level, subbands L², HL, LH and HH are column processed 17 (FIG. 11e). The 25.3 MHz clock rate (clk_{row2}) transitions to 50.5 MHz (clk_{col1}). After column processing 17, subbands L and H each comprising 1024×1024 coefficients are written into a first level column storage element 79 and are available for row processing 33. The memory required would be 16,777,216 bits, or 2,097,152 bytes for all coefficients of one subband. Since there are two subbands and memory spaces are employed, the total subband memory required for the first level column storage element 79 is approximately (2,097,152 bytes)×(2 subbands)×(2 memory spaces)≅8 MB. The 50.5 MHz clock rate (clk_{col1}) transitions to 101 MHz (clk_{row1}) during row processing 17.

The above example shows the method of the invention as applied to one type of signal processing transform, the IDWT, requiring multiple temporal stages, each stage having a storage element allocating memory spaces and its own operating frequency and voltage for maximum power efficiency. The invention can likewise be used to derive pipeline stages for a DWT, DCT, IDCT and other signal processing streaming calculations.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

What is claimed is:

1. A method for implementing a computation as a pipeline that processes streaming data comprising:
partitioning the computation into a plurality of temporal stages, each said stage having at least one input and at least one output, wherein one of said stages is a first stage having at least one primary input, and one of said stages is a last stage having at least one primary output, with each said stage defined by a clock frequency;
forming a pipeline by coupling at least one output from said first stage to at least one input of another one of said plurality of stages, and coupling at least one output from another one of said plurality of stages to at least one input of said last stage;
assigning a clock frequency to each one of said stages in said pipeline such that an overall throughput requirement is met and not all of said assigned stage clock frequencies are equal; and
assigning to each said stage in said pipeline a supply voltage wherein not all of said assigned stage supply voltages are equal.

2. The method according to claim 1 wherein each one of said stages comprise at least one operation.

3. The method according to claim 2 further comprising synthesizing said at least one operation for each one of said stages into circuit elements.

4. The method according to claim 3 further comprising reducing said circuit elements for each one of said stages into hardware, said hardware exhibiting a predetermined latency.

5. The method according to claim 4 wherein each one of said stages has a respective voltage threshold defined by said stage hardware and said supply voltage assigned to a respective stage is greater than its respective voltage threshold.

6. The method according to claim 5 wherein said last stage assigned clock frequency is set at a minimum value that maintains the throughput requirement at said primary output.

7. The method according to claim 6 wherein each said stage assigned clock frequency is set at a minimum value that maintains the throughput requirement at said primary output.

8. The method according to claim 7 wherein each said stage assigned supply voltage is determined in proportion to its respective clock frequency.

9. The method according to claim 8 further comprising inserting at least one storage element in at least one of said plurality of stages in said pipeline to allow for operational independence between said storage element stage and another one of said plurality of said stages.

10. The method according to claim 9 wherein each said storage element allocates a first and a second memory space, said first and said second memory spaces are accessed by a write function for writing data to and a read function for reading data from, said write and said read functions access either said first or said second memory spaces in any predetermined pattern.

11. The method according to claim 10 wherein said write and said read functions access said first and said second memory spaces exclusively.

12. The method according to claim 11 wherein said first and said second memory spaces have a memory capacity that is equal to or greater than the latency of a following stage.

13. An inverse discrete wavelet pipeline comprising:
at least one reconstruction channel having a low input, a high input and an output;
a row processing stage comprising:
a row reconstruction channel; said row reconstruction channel output coupled to a row stage storage element first input, said row storage element having a corresponding first output and said row storage element having a second input and a corresponding second output, a third input and a corresponding third output, and a fourth input and a corresponding fourth output.

14. The pipeline according to claim 13 further comprising a column processing stage comprising:
first and second column reconstruction channels;
said first column reconstruction channel output coupled to a column storage element first input, said column storage element having a corresponding first output, said second column reconstruction channel output coupled to a second input of said column storage element, said column storage element having a corresponding second output.

15. The pipeline according to claim 14 further comprising a level, said level comprising:
a column stage coupled to a row stage, wherein said column storage element first output is coupled to said row reconstruction channel low input, said column storage element second output is coupled to said row reconstruction channel high input defining a level whereby said column first reconstruction channel low and high inputs and second reconstruction channel low and high inputs are subband coefficient inputs, and said row storage element first, second, third and fourth outputs are subband coefficient outputs.

16. The pipeline according to claim 15 further comprising a plurality of levels, wherein one level is an n^{th}-level for receiving n^{th}-level subband coefficients, and one of said levels is a first level for outputting a complete reconstruction whereby said subband coefficient outputs from said n^{th}-level are coupled to subband coefficient inputs of another one of said plurality of levels, and subband coefficient outputs from another one of said plurality of levels are coupled to subband coefficient inputs of said first level.

17. The pipeline according to claim 16 wherein each stage is defined by a stage clock frequency and a stage supply voltage.

18. The pipeline according to claim 17 wherein each stage exhibits a predetermined latency.

19. The pipeline according to claim 18 wherein each stage has a respective voltage threshold and said stage supply voltage is greater than its respective voltage threshold.

20. The pipeline according to claim 19 wherein said first level row stage clock frequency is set at a minimum value that maintains a reconstruction throughput requirement.

21. The pipeline according to claim 20 wherein each stage clock frequency is set at a minimum value that maintains said reconstruction throughput requirement.

22. The pipeline according to claim 21 wherein each said stage supply voltage is in proportion to its respective clock frequency.

23. The pipeline according to claim 21 wherein all of said stage supply voltages are equal.

24. The pipeline according to claim 21 wherein not all of said stage supply voltages are equal.

25. The pipeline according to claim 22 wherein said storage elements in the pipeline allow for operational independence between each said stage.

26. The pipeline according to claim 25 wherein for each said input and corresponding output of each said storage element, first and second memory spaces are allocated and accessed by a write function for writing data from each of said storage element inputs to either of said corresponding first and second memory spaces, and a read function for reading data from each of said storage element outputs to either of said corresponding first or said second memory spaces in any predetermined pattern.

27. The pipeline according to claim 26 wherein said write and said read functions access said first and said second memory spaces exclusively.

28. The pipeline according to claim 27 wherein said first and said second memory spaces contain a memory capacity that is equal to or greater than the latency of a following stage.

29. A pipeline for performing a streaming computation, the pipeline having a plurality of stages coupled together, each stage having at least one input and at least one output and one of the stages is a first stage having at least one primary input and one of the stages is a last stage having at least one primary output with each stage performing a subprocess computation comprising:
at least one storage element, said storage element having an input and an output and a first and a second memory space, said storage element input coupled to at least one output from one of the plurality of stages and said storage element output coupled to at least one input of another one of the plurality of stages, said storage element first memory space writing data output from said one of the plurality of stages in any pattern and said another one of the plurality of stages reading previously written data in any pattern from said second memory space.

30. The pipeline according to claim 29 further comprising a stage clock frequency for each one of the plurality of stages wherein each said stage clock frequency is set at a minimum value that maintains a throughput requirement.

31. The pipeline according to claim 30 further comprising a stage supply voltage for each one of the plurality of stages wherein each stage has a respective voltage threshold and said stage supply voltage for a stage is greater than its respective voltage threshold.

32. The pipeline according to claim 31 wherein each said stage supply voltage is in proportion to its respective clock frequency.
